(19) United States
(12) Patent Application Publication
(10) Pub. No.: US 2019/0376658 A1
(43) Pub. Date: Dec. 12, 2019

(54) ADHESIVE FILM FOR TINTING AUTOMOTIVE LENSES AND METHOD

(71) Applicant: VVIVID Vinyls, Saint-Laurent (CA)

(72) Inventor: Abraham ZRIHAN, Saint-Laurent (CA)

(21) Appl. No.: 16/439,265

(22) Filed: Jun. 12, 2019

Related U.S. Application Data
(60) Provisional application No. 62/684,084, filed on Jun. 12, 2018.

(51) Int. Cl. F21S 41/20; F21S 43/20

(52) U.S. Cl. CPC F21S 41/285; F21S 43/26

(57) ABSTRACT

A tint wrap for an automotive lens comprises a tint film defining an inner face comprising a dry applied adhesive overlaying a back liner defining an embossed pattern formation of peaks and valleys. This formation forms in the adhesive contiguous air channels with flat areas interposed therebetween. The air channels are connected at intersections about the flat areas and respectively define a top wall, a bottom opening and spaced apart lateral walls therebetween. The height of the channel is defined between the top wall and the bottom opening and the width between the lateral walls. The air channel width is greater than the air channel height anywhere along the air channel height. When the tint film is removed from the back liner and is mounted to the automotive lens for wrapping thereof, the air channels provide for air between the tint film and the automotive lens to be released via the peripheral edges and wherein the air channels collapse for providing the top wall of the air channels to engage the automotive lens.

### CROSS-REFERENCE TO RELATED APPLICATIONS

The present application claims priority on U.S. Provisional Patent Application No. 62/684,084 filed on Jun. 12, 2018 and incorporated by reference herein in its entirety.

### TECHNICAL FIELD

The present disclosure generally relates to tinting of automotive lenses such as headlights and taillights. More particularly but not exclusively the present disclosure relates to an adhesive film and a method for tinting automotive lenses.

### BACKGROUND

Vehicle vinyl wrapping is well known and consist of the automotive aftermarket practice of completely or partially covering a vehicle's original paint with a vinyl wrap. The tint wrap includes a back liner or release liner paper of film and tinted transparent vinyl film removably mounted thereto. The film has an exposed side and an underside mounted to a liner support side with an adhesive interposed therebetween. The adhesive is injected on the underside of the film and the then then the film is positioned on the liner support side with the adhesive engaging the support side. As is known in the art, the liner is a paper or plastic-based film sheet used to prevent a sticky surface from prematurely adhering. Automotive lenses such as the headlights and taillights of cars can also be wrapped for tinting. In some cases, a pressure adhesive film can be used to place on the lights of the vehicle. Many prior art films are not repositionable and thus users prefer using films with a liquid solution adhesive. The prior art provides various tint films provided with air egress or air release channels formed by the liner paper wrinkles, bubbles, embossments in the adhesive for allowing the tint to be repositioned.

Prior art tint wrap solutions including adhesives with air egress or air release channels are shown in FIGS. 1 to 5.

Turning to FIG. 1, there is shown a prior art tin wrap 10 including a back liner 12 for supporting a tint film 14 with an adhesive layer 16 therebetween. The back liner 12 includes a paper liner 18 defining a support side 20 for supporting the tint film 14 thereon and an opposite side 22.

A pattern forming surface 24 is provided on the support side 20 by a silicone coating 26 which is embossed in order to define peaks 28 and valleys 30. The peaks 28 are ‘geometric’ in shape forming a top angle or summit 31 and providing a triangular configuration. The peak 28 usually has a substantial height above the valley 30 and a bottom (at valley level) width of about 1/12th to about 1/20th of a centimeter. Given, the triangular configuration of the peak 28, the width increases in size from the summit 31, where it is very small to near the valley 30 where it is at its widest. The body 32 of the peak 28 is inwardly recessed from the valley 28 to the summit 31 providing a triangular like configuration depending on design. The peaks 28 form corresponding channels 34 in the adhesive 16. The valleys 30 form corresponding flat surfaces 36 between the channels 34 in the adhesive 16.

The opposite side 22 the back liner 12 includes a silicone coating 38.

In FIG. 2, the combined tint film 14 and adhesive 16 have are removed from the back liner 12 and positioned on an automotive lens surface 40.

More particularly, the tint film 14 is coated with the adhesive 16 at its inner side or underside 42 and is adhesively mounted to the automotive lens surface 40. The adhesive 16 defines a tint-mounting side 44 and an opposite surface-mounting side 46. As the tint film 14 was previously disposed on the back liner 12, the adhesive surface mounting side 46 has a pattern that is complementarily configured to the pattern forming surface 24. Thus, as explained above, the peaks form air channels 34 in the surface mounting-side 46, that form complementary peaks 48 in the tint-mounting side 44 causing complementary peak projections 50 in the exposed side 52 of the tint film 14. Similarly, the valleys 30 cause complementary flat areas 36 in the adhesive supporting mounting surface 46 causing complementary valleys 54 in adhesive tint mounting side 44 further causing complementary valleys 56 in the tint exposed surface 52.

As shown in FIG. 7, the pattern forming surface 24 defines several peaks 28 and valleys therebetween within a distance D of about 1 mm in surface 24 width.

FIG. 3 shows a prior art adhesive 16′ on the inner side 44′ of the tint film 14′. The pattern in adhesive 16′ shows air channels 34′ and flat areas 36′. FIG. 10 shows a prior art adhesive 16″ on the inner side 44″ of the tint film 14″. The pattern in adhesive 16″ shows air channels 34″ and flat areas 36″. The tint films 14′ and 14″ define respective first opposite edges L and R and second opposite edges F and B. In both prior art patterns in adhesives 16′ and 16″ the air channels 34′ and 34″ surrounding flat areas 36′ and 36″ meet at intersections 58′ and 58″ respectively. The intersections 58′ and 58″ of each adhesive pattern 16′ and 16″ are co-linear along a given row line W-W between opposite edges L and R and co-linear along a given column line C-C between opposite edges F and B.

With reference to FIG. 2, the air channels 34 of the prior art pattern in the adhesive 16 do not fully collapse as they trap air a therein causing a tint film exposed surface 56 to be distorted as it has a texture projected from the air channels 34.

FIG. 5 shows the prior art tint film 14 on a surface 40 with the non-collapsed air channels 34 (including trapped air) showing through and appearing as tiny bumps 60.

### Objects

An object of the present disclosure is to provide tint wrap for tinting automotive lenses.

An object of the present disclosure is to provide a film for tinting automotive lenses.

An object of the present disclosure is to provide a kit for tinting automotive lenses.

An object of the present disclosure is to provide a method for tinting automotive lenses.

### SUMMARY

In accordance with an aspect of the present disclosure, there is provided a tint wrap for an automotive lens comprising: a tint film for wrapping the automotive lens for tinting thereof, the tint film defining opposite outer and inner faces and being bounded by peripheral edges defining a surface area therebetween, the inner surface comprising a dry applied adhesive for being adhesively mounted to the automotive lens; and a back liner supporting the tint film thereon, the back liner comprising an outer rear surface and an opposite inner support surface defining an embossed pattern formation thereon of peaks and valleys, the tint film overlaying the back liner with the inner face of the film engaging the support surface, the formation forming a corresponding pattern formation in the adhesive extending the surface area of the film between the peripheral edges and defining contiguous air channels with flat areas interposed therebetween, the air channels being connected at intersections about the flat areas, each air channel defining a top wall, a bottom opening defining a plane thereof and spaced apart lateral walls therebetween, the top wall and the bottom opening defining an air channel height therebetween, the spaced apart lateral walls defining an air channel width therebetween, wherein the air channel width is greater than the air channel height anywhere along the air channel height, wherein when the tint film being removed from the back liner and being mounted to the automotive lens for wrapping thereof, the air channels provide for air between the tint film and the automotive lens to be released via the peripheral edges and wherein the air channels collapse for providing the top wall of the air channels to engage the automotive lens.

In accordance with an aspect of the present disclosure, there is provided a tint film for wrapping the automotive lens for tinting thereof, the tint film defining opposite outer and inner faces and being bounded by peripheral edges defining a surface area therebetween, the inner surface comprising dry applied adhesive for being adhesively mounted to the automotive lens; a pattern formed in the adhesive extending the surface area of the film between the peripheral edges and defining contiguous air channels with flat areas interposed therebetween, the air channels being connected at intersections about the flat areas, each air channel defining a top wall, a bottom opening defining a plane thereof and spaced apart lateral walls therebetween, the top wall and the bottom opening defining an air channel height therebetween, the spaced apart lateral walls defining an air channel width therebetween, wherein the air channel width is greater than the air channel height anywhere along the air channel height, wherein when the tint film being mounted to the automotive lens for wrapping thereof, the air channels provide for air between the tint film and the automotive lens to be released via the peripheral edges and wherein the air channels collapse for providing the top wall of the air channels to engage the automotive lens.

In accordance with an aspect of the present disclosure, there is provided a kit for tinting an automotive lens, the kit comprising: a tint film for wrapping the automotive lens for tinting thereof, the tint film defining opposite outer and inner faces and being bounded by peripheral edges defining a surface area therebetween, a dry adhesive for being coated on the inner surface of the film for being adhesively mounted to the automotive lens with the film; and a back liner for supporting the tint film thereon, the back liner comprising an outer rear surface and an opposite inner support surface defining an embossed pattern formation thereon of peaks and valleys, the tint film being provided to overlaying the back liner with the inner face of the film engaging the support surface, the formation forming a corresponding pattern formation in the adhesive extending the surface area of the film between the peripheral edges and defining contiguous air channels with flat areas interposed therebetween, the air channels being connected at intersections about the flat areas, each air channel defining a top wall, a bottom opening defining a plane thereof and spaced apart lateral walls therebetween, the top wall and the bottom opening defining an air channel height therebetween, the spaced apart lateral walls defining an air channel width therebetween, wherein the air channel width is greater than the air channel height anywhere along the air channel height, wherein when the tint film is coated with the adhesive and positioned on the back liner and then removed from the back liner and mounted to the automotive lens for wrapping thereof, the air channels provide for air between the tint film and the automotive lens to be released via the peripheral edges and wherein the air channels collapse for providing the top wall of the air channels to engage the automotive lens.

In accordance with an aspect of the present disclosure, there is provided a method of tinting an automotive lens, the method comprising: providing a tint film for wrapping the automotive lens for tinting thereof, the tint film defining opposite outer and inner faces and being bounded by peripheral edges defining a surface area therebetween, coating the inner surface of the tint film with a dry adhesive for being adhesively mounted to the automotive lens with the film; and forming a pattern formation in the adhesive extending the surface area of the film between the peripheral edges and defining contiguous air channels with flat areas interposed therebetween, the air channels being connected at intersections about the flat areas, each air channel defining a top wall, a bottom opening defining a plane thereof and spaced apart lateral walls therebetween, the top wall and the bottom opening defining an air channel height therebetween, the spaced apart lateral walls defining an air channel width therebetween, wherein the air channel width is greater than the air channel height anywhere along the air channel height; and mounting the tint film with the adhesive to the automotive lens for wrapping thereof, wherein the air channels provide for air between the tint film and the automotive lens to be released via the peripheral edges and wherein the air channels collapse for providing the top wall of the air channels to engage the automotive lens.

In an embodiment, the width to height ratio of the air channels is from about 10:1 to about 20:1. In an embodiment, the width to height ratio of the air channels is about 16:1.

In an embodiment, the top wall comprises a generally domed configuration. In an embodiment, the top wall comprises a generally flat configuration.

In an embodiment, the lateral walls are inwardly inclined from the bottom opening to the top wall.

In an embodiment, the flat areas define respective widths separating a pair of the air channels. In an embodiment, the respective widths of the flat areas are about 1 mm in length. In an embodiment, the width to width ratio of the flat areas to the air channels is about 6:1 to about 13:1. In an embodiment, the width to width ratio of the flat areas to the air channels is about 10:1.

In an embodiment, the intersections between a pair of laterally opposed peripheral edges are non-colinearly disposed along a contiguous pathway In an embodiment, the contiguous pathway comprises a zig-zagging configuration.

In an embodiment, the corresponding pattern in the adhesive comprises an orange peel texture.

In an embodiment, the tint film has a thickness of about 3 mils.

In an embodiment, the adhesive comprises acrylate.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 (Prior Art) is a cross-sectional view of a prior art tint wrap;

FIG. 2 (Prior Art) is a cross sectional view of a prior art tint film previously positioned on the back liner of FIG. 1 and now mounted on an automotive lens;

FIG. 3 (Prior Art) is a 500×-1000× magnified photo of a prior art adhesive on a tint film;

FIG. 4 (Prior Art) is a 500×-1000× magnified photo of another prior art adhesive on a tint film;

FIG. 5 (Prior art) is a close-up photo of a prior art tint on a surface;

FIG. 6 is a top view of a tint wrap in accordance with a non-restrictive illustrative embodiment of the present disclosure;

FIG. 7 is a rear view of the tin wrap of FIG. 1;

FIG. 8 is a cross-sectional view of a tint wrap taken along line 8-8 of FIG. 1 in accordance with a non-limiting illustrative embodiment of the present disclosure;

FIG. 9 is an enlarged view of portion 9 of FIG. 8 when the tint film and adhesive have been removed from the back liner;

FIG. 10 is a top plan view of the underside of the tint film of the tint wrap of FIG. 8 with the adhesive on the underside thereof in accordance with a non-limiting illustrative embodiment of the present disclosure;

FIG. 11 is a cross sectional view of the tint film of FIG. 10 mounted on an automotive lens in accordance with a non-limiting illustrative embodiment of the present disclosure;

FIG. 12 is a 500×-1000× magnified photo of an adhesive on the tint film of a tint wrap in accordance with a non-limiting illustrative embodiment of the present disclosure;

FIG. 13 is a 500×-1000× magnified photo of the tint film with an adhesive mounted to a surface in accordance with a non-limiting illustrative embodiment of the present disclosure;

FIG. 14 is a 500×-1000× magnified photo of the tint film with an adhesive mounted to a surface after a first time interval from being positioned on the surface in accordance with a non-limiting illustrative embodiment of the present disclosure; and

FIG. 15 is a 500×-1000× magnified photo of the tint film with an adhesive mounted to a surface after a second time interval from being positioned on the surface in accordance with a non-limiting illustrative embodiment of the present disclosure.

FIG. 16 is a front view of the backing of the tint wrap without the tinting film showing in accordance with a non-restrictive illustrative embodiment of the present disclosure;

FIG. 17 is a top view of an automotive lens with the tint film being mounted thereto in accordance with a non-restrictive illustrative embodiment of the present disclosure; and

FIG. 18 is top view of an automotive lens with the tint film mounted thereto in accordance with a non-restrictive illustrative embodiment of the present disclosure and with a prior art tinting film mounted thereto.

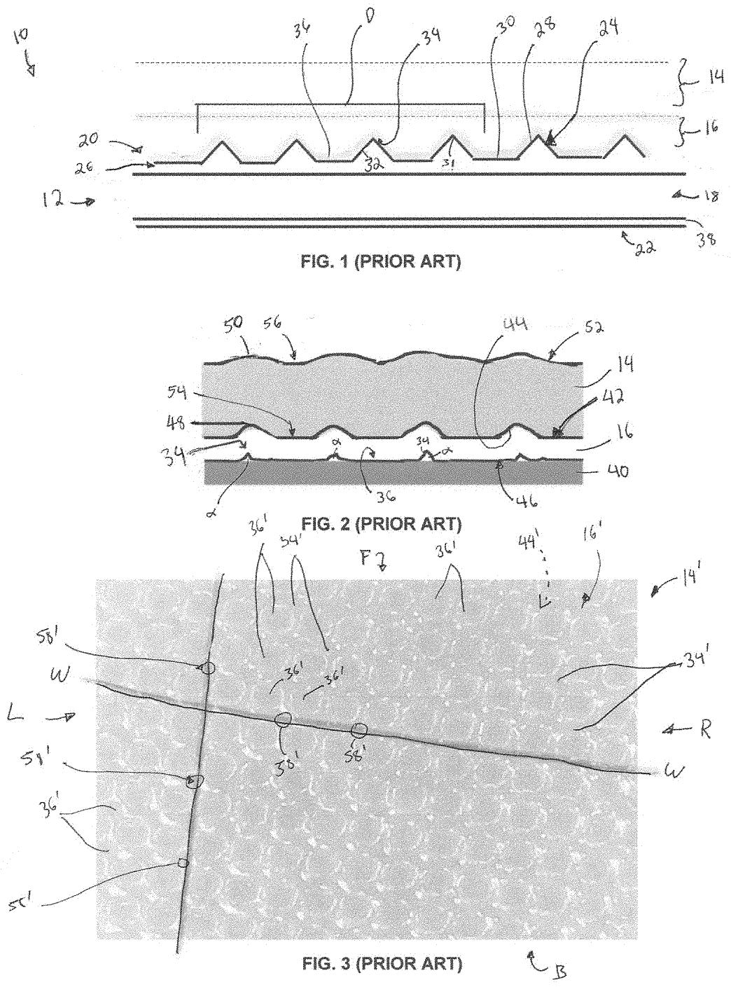

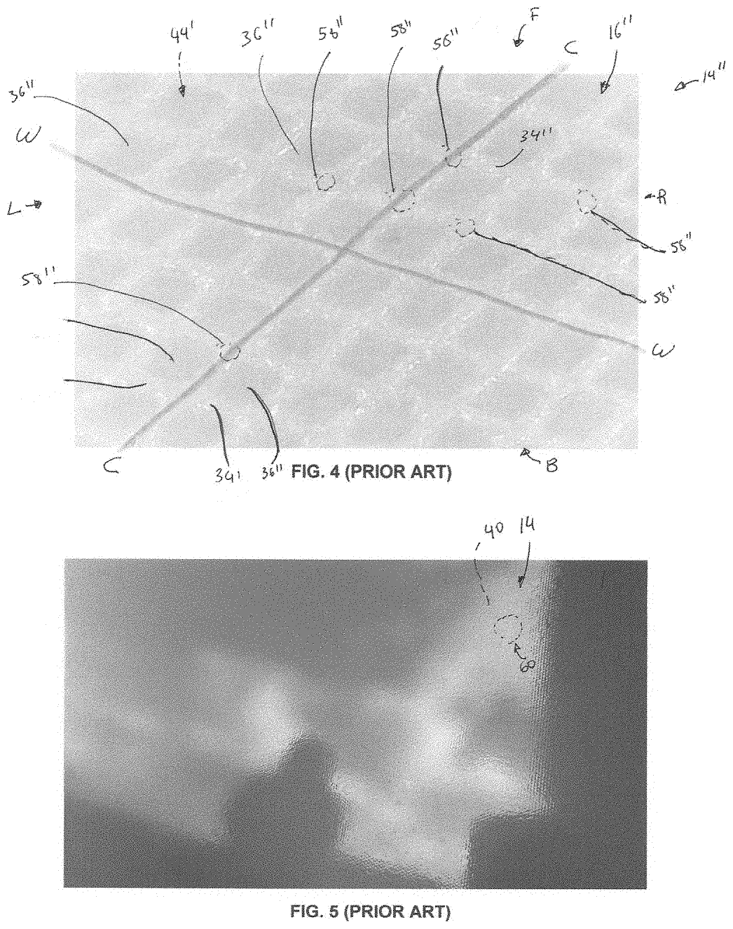

### DETAILED DESCRIPTION OF ILLUSTRATIVE EMBODIMENTS

Generally stated and in accordance with an aspect of the present disclosure, there is provided a tint wrap for an automotive lens comprising a tint film for wrapping the automotive lens for tinting thereof. The tint film defines opposite outer and inner faces and is bounded by peripheral edges defining a surface area therebetween. The inner surface comprises a dry applied adhesive for being adhesively mounted to the automotive lens. A back liner supports the tint film thereon. The back liner comprises an outer rear surface and an opposite inner support surface defining an embossed pattern formation thereon of peaks and valleys. The tint film overlays the back liner with the inner face of the film engages the support surface. The formation forms a corresponding pattern formation in the adhesive extending the surface area of the film between the peripheral edges and defines contiguous air channels with flat areas interposed therebetween. The air channels are connected at intersections about the flat areas. Each air channel defines a top wall, a bottom opening defining a plane thereof and spaced apart lateral walls therebetween. The top wall and the bottom opening define an air channel height therebetween. The spaced apart lateral walls define an air channel width therebetween. The air channel width is greater than the air channel height anywhere along the air channel height. When the tint film is removed from the back liner and is mounted to the automotive lens for wrapping thereof, the air channels provide for air between the tint film and the automotive lens to be released via the peripheral edges and wherein the air channels collapse for providing the top wall of the air channels to engage the automotive lens.

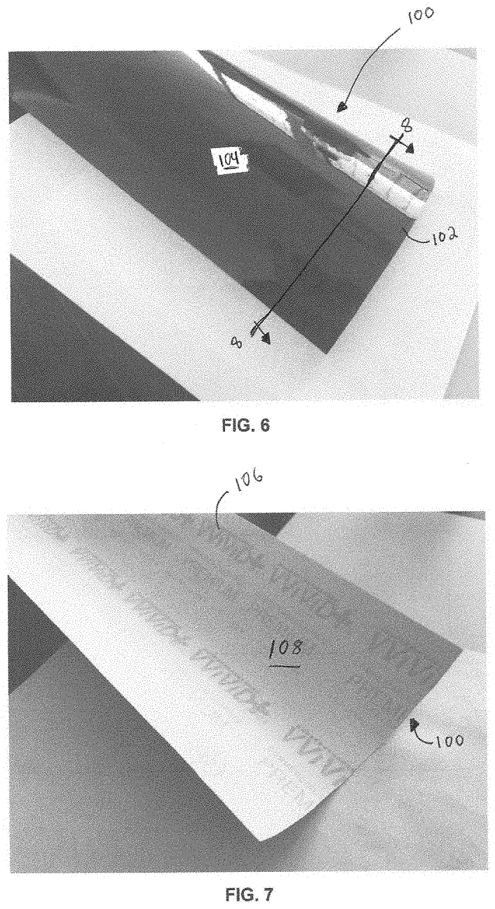

Turning now to FIGS. 6 to 18, the tint wrap will be described by way of non-restrictively illustrative embodiments.

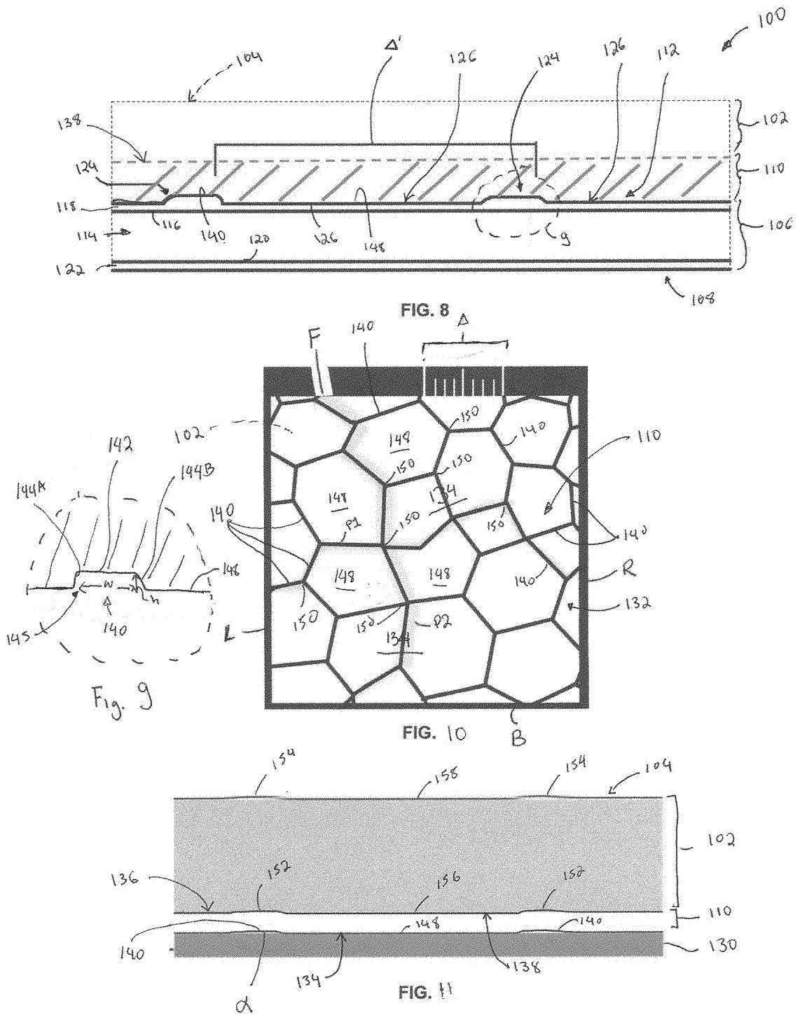

FIGS. 6 and 7 show the tint wrap 100 including a tint film 102 having an exposed outer face 104 and overlaying a back liner 106 defining an outer rear surface 108.

FIG. 8 shows the tint wrap 100 including the back liner 106 for supporting the tint film 102 with an adhesive layer 110 therebetween.

The back liner 106 defines the outer rear surface 108 and an opposite support surface 112 for receiving the adhesive layer 110 thereon. The support surface defines a pattern formation for imprinting a complementary pattern within the adhesive 110. The back liner 106 comprises a paper liner 114 coated on one face 116 thereof with a layer 118 in the form of silicone or another suitable substance defining the surface 112. The paper liner 114 is coated on its opposite face 120 with a layer 122 in the form of silicone or another suitable substance defining the outer surface 108. The pattern forming surface 112 is embossed in order to define peaks 124 and valleys 126.

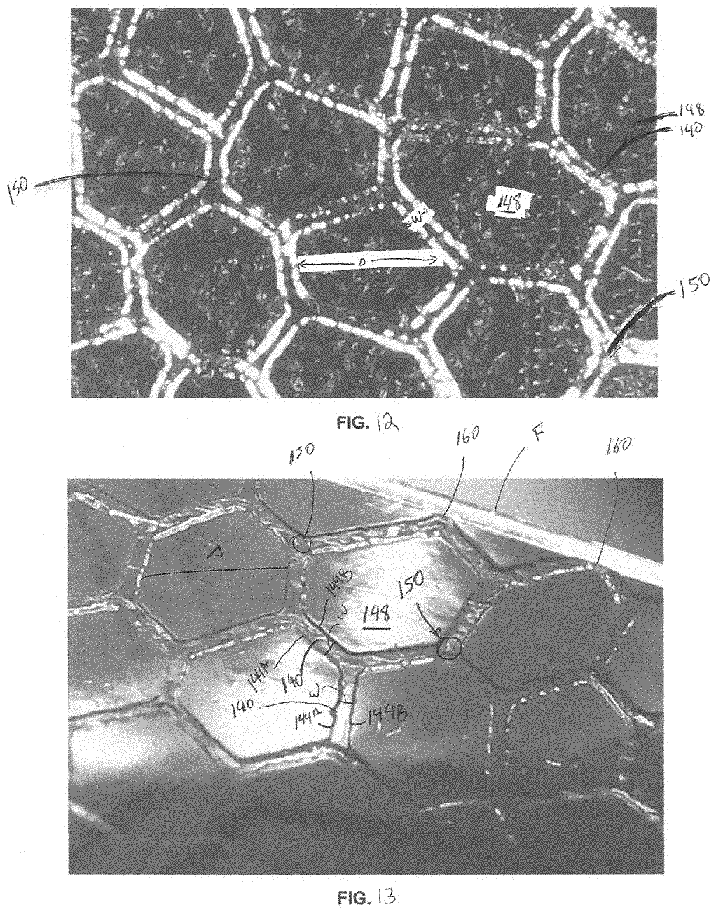

When tint wrapping a surface 130 such as an automotive lens surface (headlights or taillights), the combination of the tint film 102 with the adhesive is removed from the back liner 106 and the adhesive has a pattern 132 (see FIG. 10) imprinted on its surface mounting side 134. The tint wrap 100 can also be used on any automobile surface, yet it particularly solves problems related to automotive lens surfaces.

With reference to FIGS. 8, 10 and 11, the tint film 102 defines the outer exposed face 104 and an opposite inner face 136 receiving the adhesive 110 thereon. The adhesive 110 defines the surface mounting side 134 for engaging the pattern forming surface 112 of the back line 106 and for being mounted to the automotive lens (headlight or taillight) surface 130 for tinting. The adhesive 110 also defines an opposite tint-mounting side 138 for engaging surface 136 of the tint film 102.

With reference to FIGS. 8, 9, 10 and 11, the peaks 124 form corresponding air channel 140 in the surface mounting side 134 of the adhesive 110. In an embodiment, the peak 124 forms an air channel 140 having a width (w) of about 4 mils (1 mil= 1/1000 of an inch.) and a height (h) of about 0.25 mils. In an embodiment, the air channel 140 defines a width of 0.143 mm or 1/7th of a cm. The air channels 140 are therefore wider and shorter than the prior art air channels. As such, the air channel 140 does not have a “sharp” peak, it is a rounded dome with a generally flat or dome shaped top wall 142, spaced apart lateral wall 144A and 144B and a bottom opening 145. The width (h) is defined by opposite interfacing spaced apart lateral walls 144A and 144B. The height (h) is defined by the height of the walls 144A or 144B between the bottom opening 145 and the top wall 142. The width (w) along the height (h) of the channel 140 does not drastically change. In an embodiment, the air channel 140 comprises a width (w) to height (h) ratio of about 10:1; about 11:1; about 12:1; about 13:1; about 14:1; about 15:1; about 16:1; about 17:1: about 18:1: about 19:1; about 20:1. In an embodiment, the air channel 124 comprises a width (w) to height (h) ratio of about 16:1. In an embodiment, the lateral walls 144A and 144B are inwardly biased (i.e. being closer together at the top wall 142 than at the bottom opening 145). In an embodiment, the walls 144A and 144B are inwardly inclined by an angle of less than 90 degrees and more than 45 degrees relative to the plane of the bottom opening 145 or the plane of any width (w) along the height (h) of the air channel 140 from the bottom opening 145 to the top wall 142.

With reference to FIGS. 8, 9, 10 and 11, the valleys 126 form corresponding flat areas 148 in the surface mounting side 134 of the adhesive 110. The flat areas 148 are larger than the flat areas of the prior art. In an embodiment, the width A of a flat area 148 is about 1 mm on average. In an embodiment, the width A′ of an air channel 140 and its adjacent flat area 148 is about 1 mm on average. In an embodiment, the width ratio (A:w) of the flat areas 148 to air channels 140 is about 6:1; about 7:1; about 8:1; about 9:1; about 10:1; about 11:1: about 12:1; about 13:1. In an embodiment, the width ratio (A:w) of the flat areas 148 to air channels 140 is about 10:1.

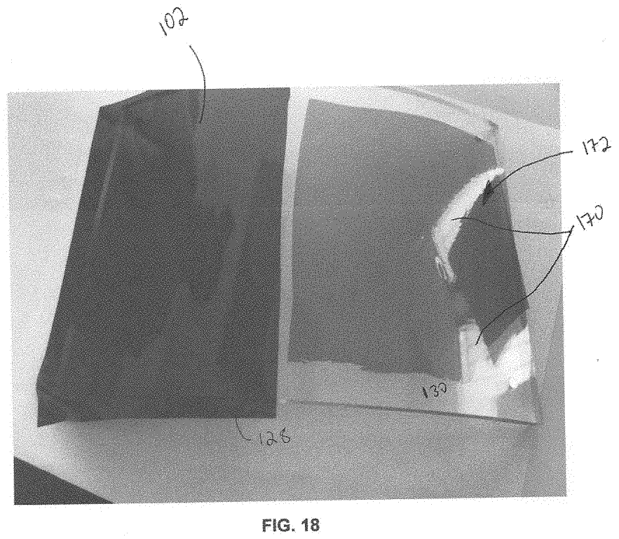

With respect to FIGS. 10, 12 and 13, the pattern 132 on the adhesive surface mounting face 134 formed by the pattern forming support surface 112 of the back liner 106 provides a “natural pattern” that it mimics the naturally occurring “orange peel” found on automotive grade paint. The pattern 132 is extend along the surface area of the tint film/adhesive combination between its peripheral edges 128 (see FIG. 18) or F, B, L, R (see FIG. 10). Layering the same pattern on each-other cancels the orange peel texture of the surface 130 offering the smoothest finish. Moreover, the intersections 150 between the channels 140 are not linear between first opposite sides L and R and second sides F and B of the film 102. Therefore, removing and repositioning the film 102 on the surface 130 removes “catching” on adhesive texture or the creation of glue lines on the surface 130 which will visually distort the outer surface 104 of the tint film 102. FIG. 10 shows the non-linear or non-colinear trajectory of the intersections 150 along a contiguous zig-zagging pathway P1 between peripheral edge sides L and R and the non-linear or non-colinear trajectory of the intersections 150 along a contiguous zig-zagging pathway P2 between sides F and B.

As previously mentioned, the air channels 140 are spaced about 1 mm apart (which is the usual width Δ of the flat area 148 defined between adjacent air channels 140), whereas in the prior art the air release or air egress channels are on average spaced about every ¼ mm making air channels 4-5 times more concentrated on the prior art film.

There are a variety of issues relating to using air egress or air channels on headlights or taillights. The design/configuration of the air channels may greatly affect the transmission of light. By spacing the air channels 140 further apart all this allows more room for the flat areas 148 thereby providing more transmission of light in comparing to air egress patters with very small geometrical patterns that are highly concentrated resulting in less transmission of light.

Turning now to FIGS. 11, 14 and 15 the configuration of air channels 140 allows them to collapse over time removing micro-bubbles in the adhesive 110.

With particular reference to FIGS. 8 and 11, peaks 124 form air channels 140 in the surface mounting-side 134 of the adhesive 110, that form complementary flat elongate peak sections 152 in the tint-mounting side 136 of the adhesive 110 causing complementary flat elongate peak projections 154 in the exposed side 104 of the tint film 102. Similarly, the valleys 126 cause complementary flat areas 148 in the surface mounting-side 134 of the adhesive 110, causing complementary valleys 156 in the tin mounting side 136 further causing complementary valleys 158 in exposed surface 104. The short height (h) of the air channel 140 causes a shorter but wider projection 154 in the tint outer surface 104. The short walls 144A and 144B collapse under the mass of the larger surface area of the top wall 142 and the weight of the adhesive 110 and film 102 pushing the air a out though the air channels 140 which are in fluid communication with the ambient environment via the openings 160 (see FIG. 13) at the film peripheral edges (i.e. edges F, B, L, and R). When the air channel 140 has fully collapsed the top wall 142, in essence closes the opening 145, and engages the surface 130. The configuration of the air channel 140 and flat area 148 provide for a smoother transition between portions 154 and 158 at the exposed surface 104 of the tint film 102 thus creating less surface bubbles and less concentration of projections. As the air channel 140 collapses this already small height differential disappears for providing a smooth outer surface 104 without glue lines projecting therethrough (when repositioning) and with the orange peel finish of the surface 130 having been cancelled.

The foregoing solves the problem of tint films with air channels that do not collapse. With the heat projected from the headlight, air trapped in the film expands further creating even more distortion and failure in the film.

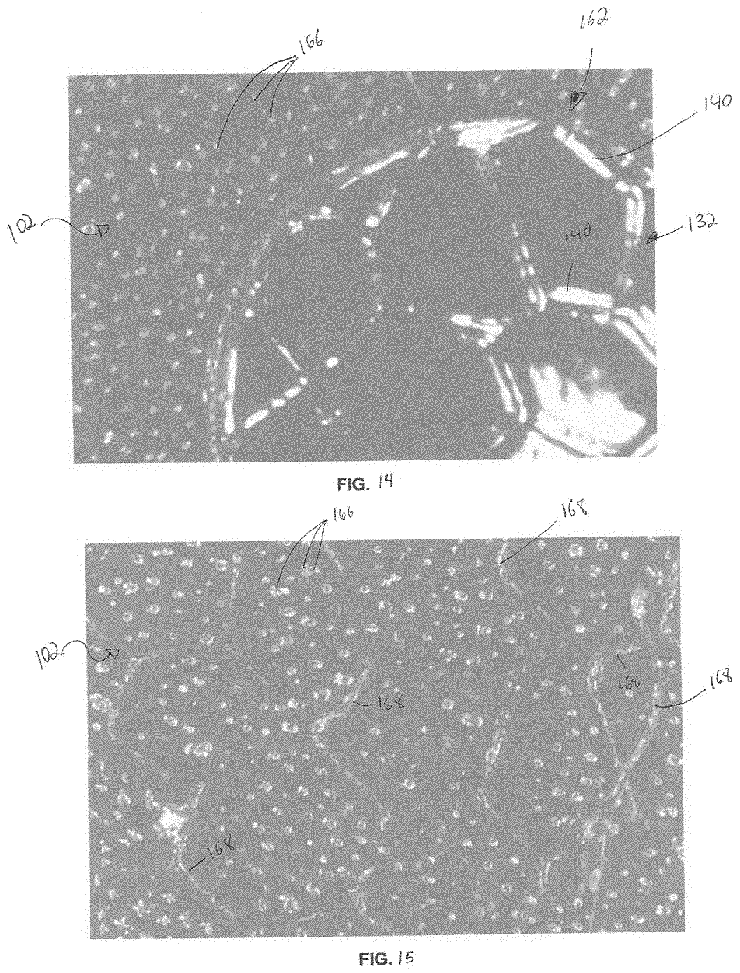

FIGS. 14 and 15 show the collapsing air-channels 140 after 1-month of installation. The film 102 was installed on glass and the areas with a distinct air-channel pattern 132 is an area 162 that was not in contact with the glass surface. The surrounding areas 164 without channels show that the air channels collapsed. The small dots 166 are deformations caused by removing the film 102 from surface 140 for demonstration purposes. In use, these dots 166 are not there, the film 102 is completely smooth. The second photo shows the remnants 168 of what is left of the air channels 140. Again, the fact that the surface 104 is not completely smooth is due to deformations caused when peeling off the film 102 from the surface 140 during demonstrations.

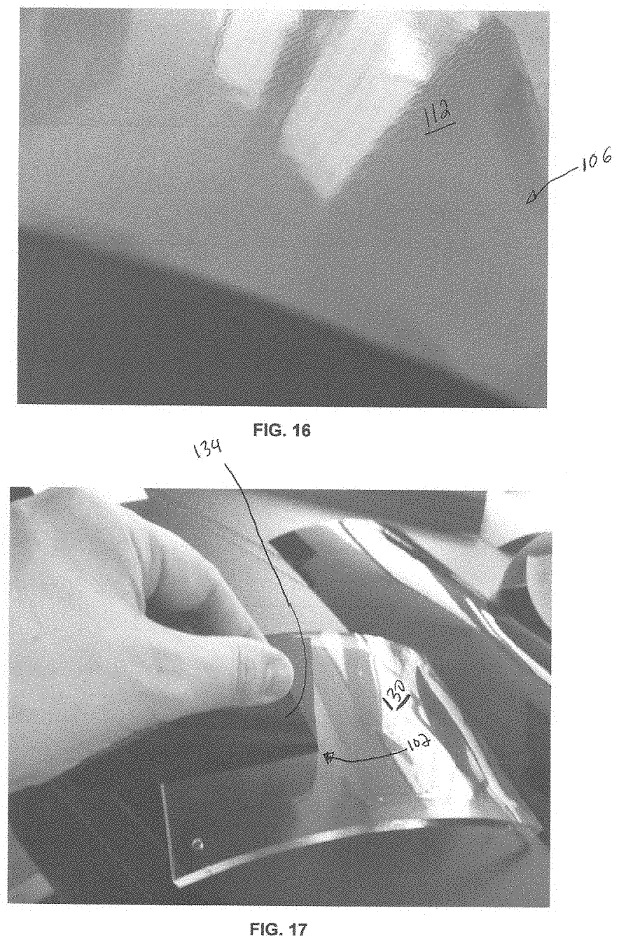

FIG. 16 shows the back liner 106 when the tint film 102 with the adhesive 110 has been removed exposing the pattern forming surface 112 which as shown in embossed to provide for the peaks 124 and valleys 126.

FIG. 17 shows the tint film 102 having been removed from the back liner 106 and exposing its inner face or underside which is the surface mounting side 134 of the adhesive 110 (such as a pressure sensitive material) coated thereon. The adhesive surface 134 has a pattern 132 imprinted thereon by the back liner 106 and provided for being removably adhered on the glass surface 130 thereby allowing to wrap the tint film 102 on the glass 130 as shown in FIG. 19.

The air channels 140 are contiguous but meet at intersections 150 that are not colinear from along the length and width of the tint film in comparison to prior art films. The adhesive 110 provides for a plurality of openings 160 (see FIG. 13) at the peripheral edges 128 of film 102 (see FIG. 18) (i.e. edges F, B, L, R) allowing for the air to escape.

Thus, the air channels 140 provide an air-release between the film 102 and the lens 130 with the air escaping via the openings at the peripheral edges 128. Moreover, the air channels 140 provide for the tint film 102 to be repositionable, easier to smooth out on the lens surface 130 and avoid the air bubbles 170 of standard tinting films 172 (see FIG. 18).

As such, the tinting film 102 is repositionable on the lens 130 and can be applied without liquid solution. Liquid based tints (wet application) are difficult to install, they require training and need to be applied on flat and slightly curved surfaces. The film 102 can thus be applied on highly curved, jagged and otherwise too difficult to wrap surfaces. Indeed, headlights and taillights are being manufactured with more intricate designs and shapes that provide challenges for standard tint films 170. Since the film 102 is repositionable it is much easier to handle.

Transparent tints on headlights are usually wet applied. Wet application basically refers to using lubricants to allow the film not to stick for repositionability purposes. Wet application is extremely difficult if not impossible on certain shapes that we commonly see in the automotive industry In the prior art, wet applying film provided optimal clarity for visual light transmission. It is a method commonly used as air pockets and distortion caused by air channels reduce visibility greatly.

In the present tint wrap 100, the air release or air egress channels 140 and collapsing channel walls 144A and 144B greatly improve visibility compared to standard methods. The present tint wrap 100 uses dry application and as such ensures the adhesive 110 is working at its full potential which is necessary when stretching and curving to complex shapes such as a headlight installation on complex surfaces. The low distortion achieved by the pattern 132 of adhesive 110 during repositionability allows easier and more reliable installation of product on complex surfaces 130. Conventionally, other adhesives and materials get marred or blurred when being applied and repositioned.

On average, a trained installer would take approximately 75 minutes to install two front headlights and require a dry period of 6 to 12 hours to seal edges with wet application. In an embodiment, the present tinting film 102 takes on average take 20-30 minutes to install without a drying or sealing period. As such, the film 102 provides for air-release which allows the film 102 to be dry applied thereby drastically reducing installation time.

Conventionally, softer, high-tack solvent-based adhesives are used on wet-apply films which makes the adhesive non-repositionable thus the reason a liquid solution is used in order to allow some movement and reduce bond on surface. If the material is lifted and repositioned, the wet apply film may be irreversibly damaged. In contrast, the film 102 is repositionable and can be lifted and reapplied with negligible damage thereto and to the adhesive.

In an embodiment, the material of the film 102 comprises transparent or translucent polymeric PVC for tinting automotive lenses (e.g. Cast PVC, Polymeric PVC and Calendered PVC). In an embodiment, the film material has a thickness of about 3 mils to 10 mils. In an embodiment, the film 102 is from about 3 mils to about 7 mils thick depending on color and finish. In embodiment, the thickness of the film 102 can be about 3 mils. In an embodiment, the material thickness is dependent on its type and color. The film material comes in different shades and colors. Of course, the material is not opaque as it is meant to diffuse light. In an embodiment, the material offers some protection against the elements. Moreover, the material is thermoformed to curved surfaces.

In an embodiment, the film 102 comprises a material that is thicker than standard films 10 or 172. A thicker material provides greater resiliency to heat expelling from the light source in headlight/taillight. This thickness also makes air channels 140 less visible giving a higher gloss finish which in turn also improves visual light transmission from the light and of course greater light transmission translates into improved safety. A thicker material on the automotive lenses also acts as a protective barrier from the elements. The thickness of the film 102, the less distortion created from air channels 140 in addition to the air channels 140 causing a more subtle lift 154 in the film outer surface 104 as well as collapsing over time due to their configuration in conjunction to the thickness of the film 102. The thickness of the film 102 also adds thermal protection as the material can take more heat from the lights. The thicker film 102 creates a more resistant barrier from elements.

A variety of suitable adhesive materials can be used. In an embodiment, the adhesive material is a pressure sensitive adhesive that is non-permanent, peelable or removable and repositionable. In a non-limiting example, the adhesive comprises acrylate or is acrylic based. Rubbers offer good shear strength, flexibility and adhesion, work well in long- and short-term applications, and are low cost. They are also prone to yellowing, do not do well with high temperatures, and require additives to sustain tack and adhesion. Acrylates offer UV-, solvent- and hydrolosis-resistance, as well as shear strength and an ability to function at temperatures between −45 and 121 degrees Celsius (C). They tend to be more expensive, and some have low creep resistance. Silicones can function within a wider temperature range, between −73 and 260 degrees C., and feature high chemical and solvent resistance. They are more expensive than acrylates.

In an embodiment, the adhesive 110 comprises: a solvent-based acrylate pressure sensitive adhesive (transparent); with the following characteristic: viscosity (centipoise) 5,500; a solid content (%) 43.0; solvent system (%); Ethyl acetate 36; Heptane 35; Isopropanol 18, Ethanol 11.

A stiffer adhesive for increased visibility and repositionability and decreases deformities by coating film with 45% less adhesive in thickness. By thinning the adhesive and lengthening curing dwell times during the coating process, adhesive that has less initial tack and a stiffer construction is achieved. As an effect of thinning the adhesive, the air channels 140 cannot penetrate as deeply through the adhesive which gives the channel 140 better chances of completely sealing itself. The adhesive 110 has a higher than average solid content and a high-range viscosity which helps in this process as well.

In an embodiment, the backing 106 comprises backing paper 114 made of silicone embossed release line. The silicone 118 embossing creates the air-channels 140 in the adhesive 110 which allows for trapped air to escape beneath the film 102. The results are a paint-like, bubble free finish (see FIG. 18). The foregoing provided for dry application and does not require liquid solutions to apply.

The backing paper 104 is also plasticized or coated (122) on its exterior side 108 to create a water and humidity-proof barrier. Uncoated backing paper can expand or shrink when absorbing humidity or drying out, this creates an uneven finish on the paper, translating to the adhesive and ultimately the surface of the film as it takes the form of the adhesive texture. This is also a safety feature as less texture on the surface lessens light diffusion and improves light transmission and focus.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

1. A tint wrap for an automotive lens comprising:
a tint film for wrapping the automotive lens for tinting thereof, the tint film defining opposite outer and inner faces and being bounded by peripheral edges defining a surface area therebetween, the inner surface comprising a dry applied adhesive material for being adhesively mounted to the automotive lens; and
a back liner supporting the tint film thereon, the back liner comprising an outer rear surface and an opposite inner support surface defining an embossed pattern formation thereon of peaks and valleys, the tint film overlaying the back liner with the inner face of the film engaging the support surface, the formation forming a corresponding pattern formation in the adhesive extending the surface area of the film between the peripheral edges and defining contiguous air channels with flat areas interposed therebetween, the air channels being connected at intersections about the flat areas, each air channel defining a top wall, a bottom opening defining a plane thereof and spaced apart lateral walls therebetween, the top wall and the bottom opening defining an air channel height therebetween, the spaced apart lateral walls defining an air channel width therebetween, wherein the air channel width is greater than the air channel height anywhere along the air channel height,
wherein when the tint film being removed from the back liner and being mounted to the automotive lens for wrapping thereof, the air channels provide for air between the tint film and the automotive lens to be released via the peripheral edges and wherein the air channels collapse for providing the top wall of the air channels to engage the automotive lens.

2. A tint wrap according to claim 1, wherein the width to height ratio of the air channels is from about 10:1 to about 20:1.

3. A tint wrap according to claim 1, wherein the width to height ratio of the air channels is about 16:1.

4. A tint wrap according to claim 1, wherein the top wall comprises a generally domed configuration.

5. A tint wrap according to claim 1, wherein the top wall comprises a generally flat configuration.

6. A tint wrap according to claim 1, wherein the lateral walls are inwardly inclined from the bottom opening to the top wall.

7. A tint wrap according to claim 1, wherein the flat areas define respective widths separating a pair of the air channels.

8. A tint wrap according the claim 7, wherein the respective widths of the flat areas are about 1 mm in length.

9. A tint wrap according to claim 7, wherein the width to width ratio of the flat areas to the air channels is about 6:1 to about 13:1.

10. A tint wrap according to claim 9, wherein the width to width ratio of the flat areas to the air channels is about 10:1.

11. A tint wrap according to claim 1, wherein the intersections between a pair of laterally opposed peripheral edges are non-colinearly disposed along a contiguous pathway.

12. A tint wrap according to claim 11, wherein the contiguous pathway comprises a zig-zagging configuration.

13. A tint wrap according to claim 1, wherein the corresponding pattern in the adhesive comprises an orange peel texture.

14. A tint wrap according to claim 1, wherein the tint film has a thickness of about 3 mils.

15. A tint wrap according to claim 1, wherein the adhesive comprises acrylate.

16. A tint film for wrapping the automotive lens for tinting thereof, the tint film defining opposite outer and inner faces and being bounded by peripheral edges defining a surface area therebetween, the inner surface comprising dry applied adhesive for being adhesively mounted to the automotive lens; a pattern formed in the adhesive extending the surface area of the film between the peripheral edges and defining contiguous air channels with flat areas interposed therebetween, the air channels being connected at intersections about the flat areas, each air channel defining a top wall, a bottom opening defining a plane thereof and spaced apart lateral walls therebetween, the top wall and the bottom opening defining an air channel height therebetween, the spaced apart lateral walls defining an air channel width therebetween, wherein the air channel width is greater than the air channel height anywhere along the air channel height,
wherein when the tint film being mounted to the automotive lens for wrapping thereof, the air channels provide for air between the tint film and the automotive lens to be released via the peripheral edges and wherein the air channels collapse for providing the top wall of the air channels to engage the automotive lens.

17. (canceled)

18. A method of tinting an automotive lens, the method comprising:
providing a tint film for wrapping the automotive lens for tinting thereof, the tint film defining opposite outer and inner faces and being bounded by peripheral edges defining a surface area therebetween,
coating the inner surface of the tint film with a dry adhesive for being adhesively mounted to the automotive lens with the film; and
forming a pattern formation in the adhesive extending the surface area of the film between the peripheral edges and defining contiguous air channels with flat areas interposed therebetween, the air channels being connected at intersections about the flat areas, each air channel defining a top wall, a bottom opening defining a plane thereof and spaced apart lateral walls therebetween, the top wall and the bottom opening defining an air channel height therebetween, the spaced apart lateral walls defining an air channel width therebetween, wherein the air channel width is greater than the air channel height anywhere along the air channel height; and
mounting the tint film with the adhesive to the automotive lens for wrapping thereof, wherein the air channels provide for air between the tint film and the automotive lens to be released via the peripheral edges and wherein the air channels collapse for providing the top wall of the air channels to engage the automotive lens.
